(19) United States
(12) Patent Application Publication
(10) Pub. No.: US 2011/0146826 A1
(43) Pub. Date: Jun. 23, 2011

(54) DOSING DEVICE AND PROCEDURE FOR PLUGGING BRANCHES IN FLUID TRANSPORT CONDUITS BASED ON SAID EQUIPMENT

(75) Inventors: Edelmira Afanador Rey, Piedecuesta (CO); Gerardo Santos Castañeda, Santander (CO); Gonzalo Leal Diaz, Santander (CO); Guillermo Latorre Cortes, Santander (CO); Hector Danilo Ordoñez Lozano, Santander (CO); Jairo Humberto Guzman Mejia, Santander (CO)

(73) Assignee: ECOPETROL S.A., Bogota (CO)

(21) Appl. No.: 12/518,047

(22) PCT Filed: Nov. 30, 2007
(86) PCT No.: PCT/IB2007/004310

§ 371 Date: Mar. 9, 2011

(30) Foreign Application Priority Data
Dec. 6, 2006 (CO) 06-123229

(51) Int. Cl. F16L 55/46; F16L 55/162

(52) U.S. Cl. 138/98; 221/208

(57) ABSTRACT

A device and a process reduce losses of fluid in transport conduits, caused by the installation of branches connected directly to conduits. The process includes injecting in the current of the fluid geometric elements of diverse materials and forms, in particular spheres, with densities similar to that of the fluid, by a special doser. The elements are circulated through the fluid, and because of hydraulic effects, the obstruction of the branches prevents or hinders extraction of the product. Recovery of the geometric elements at the end of the conduit uses a filter as a trap.

### TECHNICAL FIELD

The present invention relates to a dosing equipment which incorporates into the fluid stream geometric elements from various materials and shapes in order to avoid fluid losses in transport ducts, caused by the installation of unauthorized shunts which are directly coupled on the ducts; and the process for blocking said unauthorized shunts at pressures between 101.3 and 17400 kPa.

### STATE OF THE ART

Fluid leakage in frequent today, when installing unauthorized shunts directly coupled to the transport tubing. This problem has been especially critical in the oil field and derivatives thereof, where frequently hydrocarbons are extracted from the pipelines. In order to fight against this fact, multiple processes have been generated, which promise to be as a possible solution to this problem.

Within the solutions that have been proposed there is the U.S. Pat. No. 4,104,211 consisting in a water sealant emulsion of non-cationic bitumen and gum used for internally blocking duct leaks, in particular gas leaks. Even though this process works well, in view of its characteristics it is not applicable to liquid transport systems. In opposition to that approach, the present invention uses geometric elements which are injected into the fluid stream in a controlled amount in time through a regulator, and by hydraulic forces the unauthorized shunts or leaks are blocked from inside the process line.

Another option to overcome this problem is U.S. Pat. No. 4,643,855 which suggests the injection of an expansible tubular plug and using an anaerobic curable monomer as sealant. This patent describes how tubing joints and leaks are blocked by injecting sealant at the joint through a expansible tubular plug which is moved within the tubing. The plug formed in the tubing an airless space which communicates with the joint or leak and which is well isolated from the fluid. The plug is hollow so that it allows the fluid to pass through, while the joint or leak are sealed. The sealant is constituted by a curable anaerobic monomer under air free conditions at the joint or leak, thus it is injected in the joint or leak in a manner to be cured in situ. This approach is different to the technique shown in the present invention, because in the present invention not only one element but a limited amount of geometric bodies made out of a polymeric material having determined mechanic properties such as hardness and elasticity makes easier the work.

Among the processes based in the introduction of geometric elements into the fluid stream, which travel with the fluid blocking the unauthorized shunts and making difficult the non authorized extraction thereof, U.S. Pat. No. 3,144,049 is highlighted, which refers to a method for leak sealing in hydrocarbon transport conduits through plugs made of elastomeric, deformable and porous material (Neoprene), having a similar density to that of the fluid, which are incorporated into the fluid through an equipment directly adapted on the main conduit which uses an external driving force, such as pressurized gas. In a different manner, the present invention uses an injection equipment which uses the fluid pressure in order to incorporate geometric elements which have a density between 40 and 120% of the fluid density, thus obtaining the objective of sealing the leaks from inside of the tubing. In addition, given that U.S. Pat. No. 3,144,049 works with elements having the same density of the fluid it is not possible to block leaks around the 360° of the flow area.

In the same line, we found U.S. Pat. No. 4,582,091 which describes a method consisting in dispersed particles in a material cake having higher density than that of the fluid and some of the particles have greater size than the hole size of the leak. The particles are not deformable. This patent refers specifically to a process used for reducing the amount of fluid leaking from a conduit, through the introduction of particles into the liquid. The particles are dispersed in a high viscosity “pouch” material; wherein the size of at least some of the particles is bigger than that of the hole to be sealed. The position of introduction of the pouch is such that the particles containing pouch is carried by the liquid towards the hole where the particles with no deformation are lodged in it, sealing it without being expelled by the fluid pressure. Different from that, the process of the present invention relates an amount of geometric elements dispersed in the transported fluid, which travel to average velocity of 70 to 100% of the fluid velocity, therefore not generating a pressure fall within the tubing or an increase in energy waste.

Patent Application WO 03/093713 discloses a method for reducing filtrations by leaks in conduits, in which the leak is defined in terms of its maximum dimension and the effective size of the sealant elements, given in a formula. The sealing of the leak is produced by a pressure difference and uses hundreds to thousands of these sealant elements for blocking small leaks, 0.1 l/min.

Different from disclosure of the PCT application, the process herein claimed uses a limited amount of geometric elements, wherein their size is given by a statistic estimation of the perforation diameters existing in the line, which, different from the above patent, are regulated using an automatic equipment, specially designed to that purpose, with which the input frequency of the elements into the main flow in the tubing can be regulated. On the other hand, the process of this present application, has been specially designed, evaluated and proven at an industrial level under pressures up to 17400 kPa and blocking leaks having a diameter of 40 mm, equivalent to a flow of 150000 l/min, of products comprising water, raw oil, oil refined products, dangerous and common use chemical products.

In addition, patent WO 03/093713 injects the sealant elements through the scraper launching trap or “hot tapping” close to the leak. Therefore it is necessary to know the location of the leak. The present invention incorporates the elements with an additional equipment into the tubing which allow a continuous injection of geometric elements blocking unauthorized shunts in any place along the conduits.

Patent application US2003/016391 claims a process for controlling leaks using an apparatus or equipment formed by a sheet type sealant element, to which different bodies are added which give it different floatabilities and that through pressure differential are able to block leak up to 42 l/min in fluid transport conduits having a flow rate of 1200 l/min and a pressure up to 104.4 kPa, for which it is necessary to inject into the conduits a plurality of elements. On the contrary to that proposal, the process of the present invention the sealant elements are injected in limited amounts and are controlled by an automatic regulating equipment; the elements on their own have different densities, therefore are able to block holes or leaks all around 360° of the inner conduit surface, working at pressures up to 17400 kPa in lines transporting up to 480,000 l/min, and that may suffer leaks having a diameter up to 40 mm (150,000 l/min).

On the other hand, patent application EP0035857 uses the same concept for blocking holes using spheres having different material and densities; furthermore it uses a regulating equipment for introducing said spheres into the fluid which comprises an atmospheric hopper, a feeding screw and pistons that force the spheres into the fluid. The regulator of the present invention uses energy from the fluid for achieving the incorporation of the spheres into the fluid, using for that a totally different system wherein the spheres are loaded in channels or tracks under the same pressure as the conduits.

Now, as previously exposed, the regulator plays an important role in the claimed process in that it introduces the elements into the conduit flow under certain conditions in order to guarantee process success. Therefore, next we will emphasize the state of the art related with equipments that have the same function.

It has been found that U.S. Pat. No. 5,735,439 (Apparatus for the metered discharge of bulk material from a flexible supply container especially in a dosing system), reports a dosing mechanism equipped with a bin type in bulk container having at least a mobile or flexible wall portion which is moved with the help of the bulk material unloading through an unloading device.

Also, it has been established that U.S. Pat. No. 6,431,399 (Pharmaceutical dosing dispenser), discloses a pill dispenser which allows two or more alternate manners of unloading pharmaceutical medicaments, such as pills, film pills, coated pills, or capsules. The pill dispenser has a housing, a base plate, at least two storage containers for receiving and storing a medicament solid form, and a dosing gate. The base plate located in the bottom of the housing has at least an expelling aperture system. The storage containers are adapted to receive and store the medication solid forms and present a bottom aperture. The dosing gate is movable, is mounted between the storage containers and the base plate and has hiding apertures provided in such way that one of the apertures can be placed in a bottom aperture of a storage container and above an expelling aperture.

Another regulator complying with the same function is shown in U.S. Pat. No. 6,578,743 (Dosing devices for bulk goods) which refers to a medication device which includes a bin (1) with an outlet aperture that is closed by two spherical halves (3, 4), that can be rotated. The rotation movement is carried out by two arms (5, 6) on a common pivot pin (8). Both big and small amount can be dispensed in exact dose with this device.

On the other hand, U.S. Pat. No. 6,672,297 (Baseball pitching machine) protects a baseball pitching machine which includes a support on which a box is mounted on to accommodate a friction wheel operatively engaged to a motor. A tube in mounted to the box which allows a ball path in communication with the box. The tube includes a direct shooting section and an angled feeding section having an input aperture for which the lid is connected. The lid is normally closed for preventing foreign elements coming into the pitching machine. A detection member is mounted in the input aperture of the feeding section and is driven by the lid opening in order to send an audio warning through a speaker. The lid has stopping plates for preventing the ball to travel directly to the punching section before the lid is closed.

In general, the cited patents are related with equipments for dosing different types of elements under different principles to that used in the present invention which is based on screw, nut and ratchet, on the other hand the claimed equipments of the listed patents work under very low pressure similar to atmospheric.

Thus, it is clear that there is a need in the state of the art for developing an improved process for preventing fluid leaks through unauthorized shunts which is useful for any kind of liquid, and that guarantees a good leak seal around 360° of the flow area and that works at pressures up to 17400 kPa.

### DESCRIPTION OF THE DRAWINGS

FIG. 1A. Regulator scheme

FIG. 1B. Screw/nut/paddle system scheme

FIG. 1C. Injection mechanism scheme

FIG. 1D. Screw/nut/paddle system photograph

FIG. 1E. Control and driving system mechanism scheme

FIG. 1F. Stick scheme

FIG. 2. Scheme of the regulator and its position with respect to conduits.

FIG. 3. Scheme of the shunt and/or leaks blocking process in conduits under high pressure.

### DESCRIPTION OF THE INVENTION

The present invention is addressed to an equipment and a process for reducing fluid losses in transport conduits, caused by the installation of unauthorized shunts directly engaged to the conduits.

The claimed invention in this application is adapted to block unauthorized shunts in fluid transport conduits which have holes with a diameter between 5 mm to 40 mm, and for any type of fluid having densities between 0.4 g/cm³ and 1.2 g/cm³. Therefore, even if the process has been designed in particular to controlling hydrocarbon losses, it can be used in application for controlling losses of other fluids such as industrial waters for injection in oil producing fields, in aqueducts, etc.

The equipment and the process of the invention started from a mathematical model through which the optimum parameters of the dosing process were set:
Percentage of the density of the spheres with respect to that of the fluid.
Optimum amount of spheres to be dosed, defined according to the historical perforations or leaks statistics in the conduit.
Optimum dosing frequency.
Form of the blocking elements.

### Regulator

Now, concerning the regulator (3) which automatically applies the spheres (2) in exact dose, it is important to highlight that this constitutes the relevant equipment for carrying out the process of the present invention. The equipment should guarantee that the geometric elements dose is optimum, that is, that the introduction frequency is between 1 and 20 geometric elements per minute, preferably between 2 and 7.

The automatic regulator was specifically designed by the applicant to act on rigid, low plastic deformation spheres at room temperature and bearing a smooth surface area. To this effect the driving in its inside remains pressurized to the pressure of the transport tubing, that is, between 101.3 and 17400 kPa.

In addition to the above mentioned features, the Sphere Automatic Regulator must comply with the following characteristics:
Must be adapted to the dosing needs of a polyduct with respect to frequency and amount of geometric elements.
Geometric dimensioning which is consequent with an installation location in the multiple hydrocarbon dispatch.
Developing of a safe operation in environments with the probable presence of combustible gas.
Having the internal storage capacity of spheres consequent with the manual and current injection, under normal dosing.
Being designed according to the working, pressure and flow rate conditions, with respect to international and corporative rules.
Offering operational reliability.

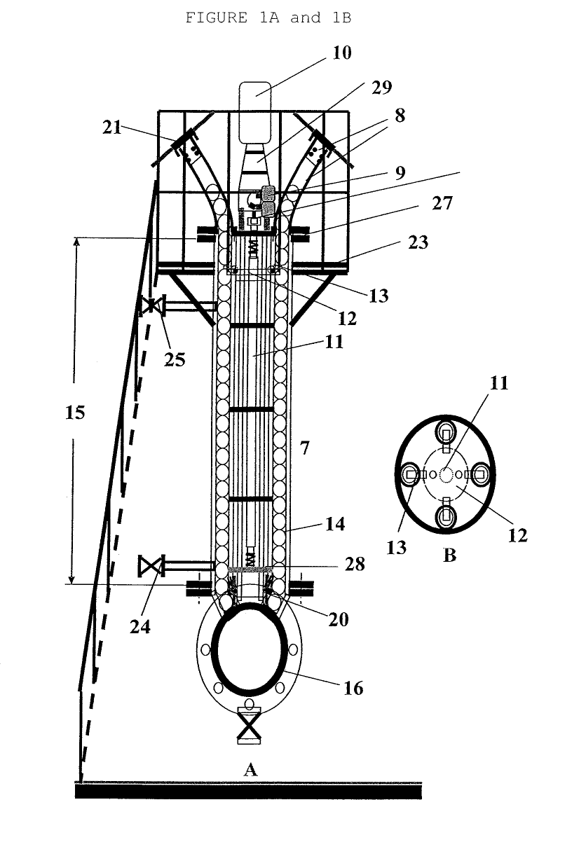

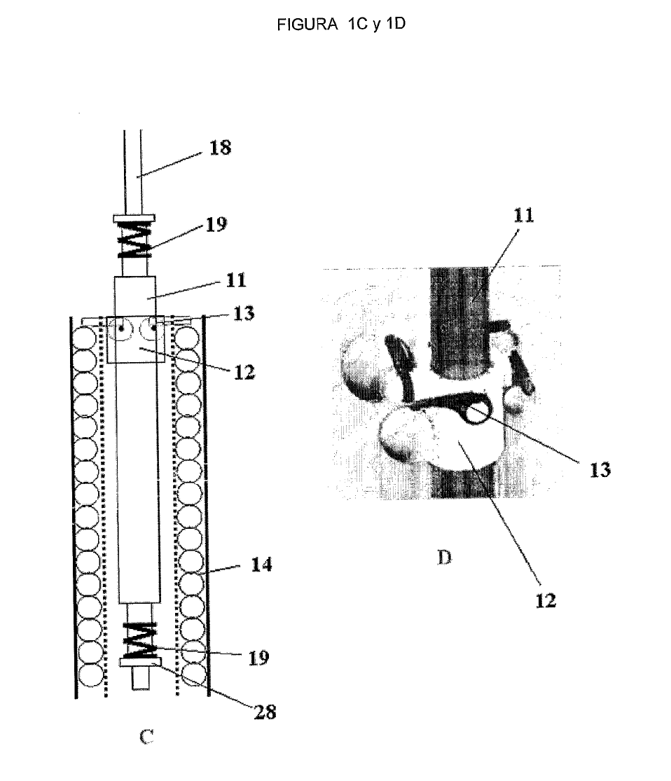

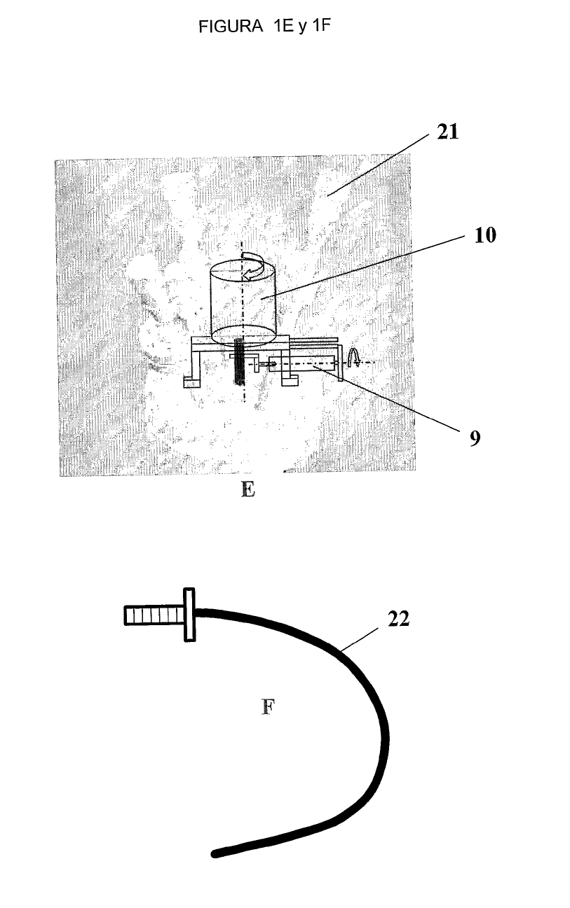

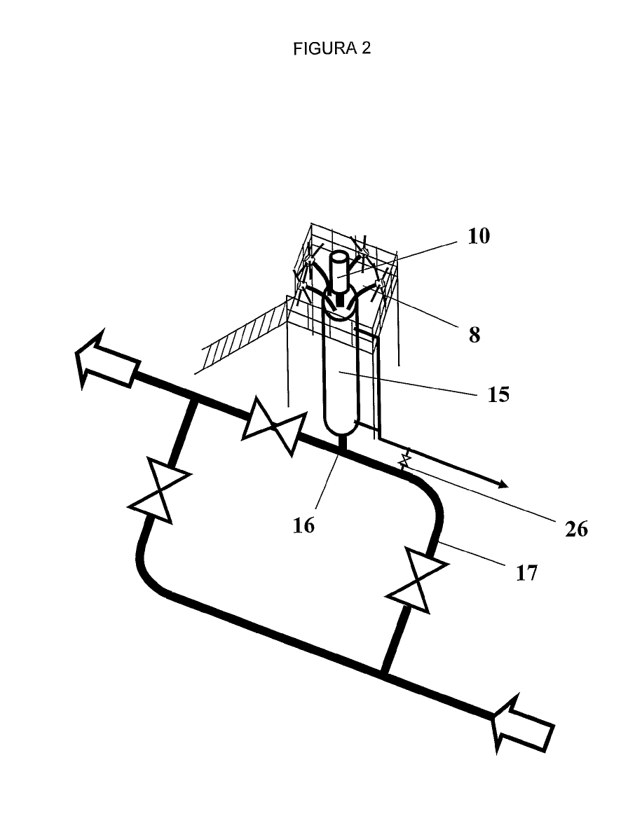

Taken as a reference the mentioned characteristics, the regulator equipment (3) shown in FIGS. 1A to 1F was developed and consists of: an injection mechanism (7), a sphere loading mechanism (8), a control mechanism (9) and a driving system (10).

### Injection Mechanism

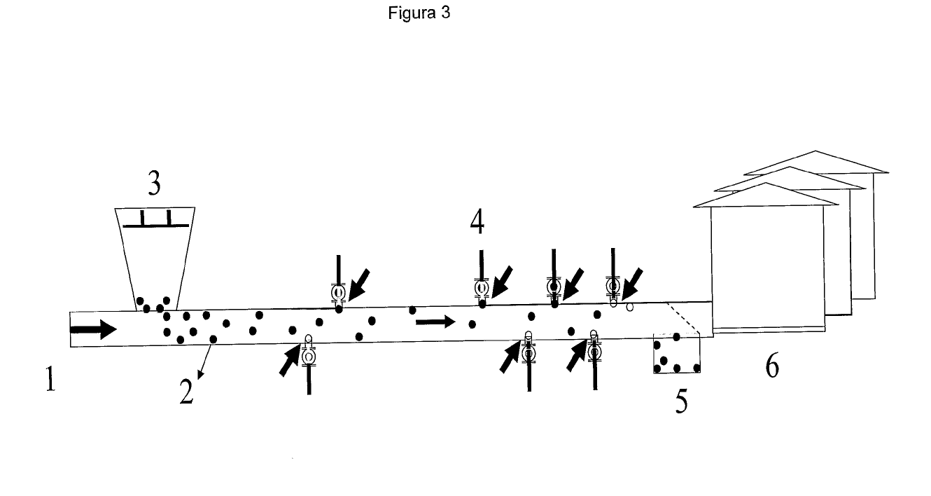

The injection mechanism (7) is constituted by a screw (11)-nut (12)-paddle (13) set which exerts pressure on the spheres (2) within a “track” (14) which guide the spheres along the main body (15) of the regulator (3), and from the loading system (8) to the T (16) which is installed in the by-pass (17) (see FIG. 2). The screw (11) is formed by a rod portion (18) having 2 in. diameter, threaded in almost all the length, with unloaders in the ends (19), in order to avoid shocks against the main nut (12), and is supported on its ends by frictional bearings made of bronze aluminum, and with the top end extended for receiving the pressure seal (30), which prevents leaks of product and allows the operation of the driving system (10).

The pressure seal (30) is constituted by a set of five rings made of a special material and having an appropriate configuration to avoid product leakage, less than 500 ppm, according to the corresponding API norm.

At the lower end of each track (14), there are ratchet mechanisms (20), which momentarily and controllably retain dispensing the spheres to the T (16) of the by-pass (17). Their design allow the axial force to push the retention spring, gradually in order to avoid collapsing the spheres and blocking the same.

### Sphere Loading Mechanism

The loading mechanism (8) is constituted by a set of 4 curved tubes having valves at their ends and/or capped with threaded caps (21), held by the top flange (27) (the same containing the previously mentioned pressure seal (30), and the driving system (10) described below). Each threaded cap (21) has a design that facilitates the manual set with no additional force required to the manual, and without allowing leaks at normal working pressures.

In order to feed, each sphere size possess a push element generically named “stick” (22), FIG. 1F, which is introduced each time 5 spheres are added during the loading process, in order to force them to correctly lodging in their respective track. Due to its function, there is a stick for each sphere size and its configuration is special (See FIG. 1F).

It is important to note that only a specific size sphere can be loaded in the specific curved tube and with the determined stick for the respective size. Different actions can give rise to blockages implying usually the need to disassemble all the inner body of the regulator.

### Control Mechanism (9)

In order to control dosing in the equipment, an open loop control system was designed, in which a control point is established (Hz of the engine velocity which is directly proportional to the dosing rate) in a velocity changer through the frequency. In the velocity changer, it is possible programming besides the engine rotation velocity for the descendent run (dosing) and for the ascending run (loading preparation) of the main nut, acceleration ramps and deceleration, measurements and other advanced programming.

Given that there is no direct feedback from the moment in which a dosing cycle starts, for determining the moment in which the advance of the main nut has reached its lower limit, it is necessary to stop and go back to the upper limit where it must stop again and wait a new cycle start, thus, it was necessary designing a mechanism that externally reflects the position of the main nut (12). This mechanism in turn, acts on two run end switches (28), influencing in the control logic of the velocity changer.

### Driving System (10)

The driving system of the equipment is formed by an electric motor (10) with a power of 2 to 5 HP, preferably 3 HP, which allows a wide range of velocity change with no abnormal reheating, and a velocity reducer (29) directly and axially coupled both to the electric motor and the main screw of the regulator. FIGS. 1A and 1E, show the electric motor-velocity reducer assembly.

### By-Pass (17)

The by-pass (17) is the polyduct facility for isolating and placing the Spheres Automatic Regulator in line. Accordingly, its configuration obeys the operating conditions of the line (pressure, temperature, transported fluids, etc.), among others. (See FIG. 2).

### Platform (23)

Platform (23) is the physical infrastructure that makes the loading process of the Spheres Automatic Regulator easy, given its height and terminal disposition of the loading curved tubes (See FIGS. 1A and 2). It is constituted by a raised platform with safety fences and access stairway. Furthermore, it possess a device in which a differential can be hung to make it easy the assembly or maintenance labor of the heavy components of the regulator.

### Functioning

The Spheres Automatic Regulator is a mechanical system constituted by a central screw, which when is rotated generates the vertical displacement of a set of “paddles” (13), which in turn bias the controlled injection of the spheres (2) contained in form of column inside the tubes named as “tracks” (14). The pressed spheres, are being expelled through the lower part of these tracks, once the springs resistance of the respective ratchets (20) have been defeated. All the mentioned components are submitted to fluid pressure under which the spheres are being injected.

The screw (11) in turn is driven from the outside of the regulator body, by an electric motor (10) which transmits rotation through the above mentioned velocity reducer (29). In addition, a control mechanism (9) allows obtain a physical replica on the outside, of the inner position of the spheres driver nut. This mechanism facilitates thus the position control of said inner nut, which affects the synchronization of the sphere loading and regulating cycle.

### Operation

The dosed spheres are loaded according FIG. 1A.

The load of spheres is done introducing them in the loading tubes according to their size, taking care of introducing only packs containing 5 elements until the maximum amount according to size has been reached. Loading is carried out in following manner:
Introducing 5 spheres into the loading tube corresponding to the size.
Pushing the spheres with the stick (22) so that they overpass the inner paddles of the regulator.
Repeating the above steps until the capacity of each loading tube (8) has been completed.
Placing the threaded caps (21) on the loading tubes (8).
Closing the threaded caps (21).

Afterwards, the operator must set the dosing frequency by modulating the variables of the Velocity changer by Frequency, verifying the conditions and status of the drainages (26) and relief valves (24, 25), and if the operative conditions of the line allow it, start the dosing cycle. This cycle requires a time proportional to the amount of spheres present in the equipment. Once the equipment has completed dosing, the reproducer mechanism acts on the dosing control system, starting the automatic return of the nut (12) and the screw (11) getting ready the system for a new sphere loading.

### Blocking Process

As seen in FIG. 3, the process begins in the dispatch station (1), located in the end point upstream of the conduit to be protected, and comprises three steps in essence: injecting into the fluid stream geometric elements having various materials and geometric shapes (2) through the dosing equipment (3) in order to guarantee an adequate dosing of the blocking elements at a pressure between 101.3 and 17400 kPa, the circulation of the elements within the fluid that by hydraulic effects block the unauthorized shunts (4) avoiding or making difficult the product extraction, and the recovery of the elements at the end of the duct using a filter as a trap (5) which catches these elements without causing any harm on them, the process ends in the receiving station (6).

### Blocking Elements

The unauthorized shunts blocking process in fluid transport conduits is based on the use of geometric elements which made of different materials and having different shapes, a mathematical model of said process allowed establishing that the spheres are the most efficient geometric elements, therefore, a better way for carrying out the process uses spheres that travel with the fluid and having diverse materials, densities, textures and mechanical properties.

The spheres are made out of materials resistant to chemical attack of the hydrocarbons transported, and reasonably to friction and impacts that may occur during the trip of the spheres. Accordingly, they can be re-used up to 5 times, according to the operative conditions. Concerning the surface texture the conclusion drawn is that the spheres should present the maximum resistance to displacement within the fluid, in order to give the necessary retention to facilitate the blocking of the unauthorized shunts. Preferably the spheres of the invention are made of polyolefin, foaming and/or mixtures thereof.

In addition, it has been established that their density must be between 40% and 120% of the fluid density. Preferably their density is between 0.4 and 1.2 g/cm³.

With respect to their size, it has been determined that their diameter must respond to the statistics of the perforation diameters. Nevertheless, it is important that the dimension of the blocking elements and the conduit diameter, be in a proportion between 1 and 10, preferably 1 and 4, so that the geometric elements do not end up blocking the conduit.

### Collection Filter (5)

The final step of the process contemplates the collection of the spheres using a collection filter having a cylinder shape and being located at the end downstream of the conduit to be protected.

The collector filter for spheres or blocking elements, consists in a vertical cylinder shaped body having a cylinder net, respective strengthening pieces, sit and handles, installed downstream of the conduit.

Its storing capacity is calculated to receive an amount equivalent to one week of sending spheres, at the normal dosing rate.

1. A regulator equipment (3) of geometric elements characterized by comprising: an injection mechanism (7) constituted by a screw (11)-nut(12)-paddle(13) set, a sphere loading mechanism (8), a control mechanism (9) and a driving system (10).

2. The regulator equipment according to claim 1 characterized in that the injection mechanism (7) comprises a screw (11)-nut(12)-paddle(13) set which exerts pressure on the spheres (2) within a track (14) which guide the spheres along the main body (15) extending from the loading system (8) to the T (16) which is installed in the by-pass (17).

3. The regulator equipment according to any of the preceding claims, characterized in that the screw (11) is formed by a rod portion (18) having 2″ diameter, threaded in almost all the length, with unloaders in the ends (19), in order to avoid shocks against the main nut (12), and is supported on its ends by frictional bearings made of bronze aluminum, and with the top end extended for receiving the pressure seal (30), which prevents leaks of product and allows the operation of the driving system (10).

4. The regulator equipment according to claim 3, characterized in that the pressure seal (30) comprises a set of five rings.

5. The regulator equipment according to claim 2, characterized in that comprises at the lower end of each track (14), ratchet mechanisms (20), which momentarily and controllably retain dispensing the spheres to the T (16) of the by-pass (17).

6. The regulator equipment according to claim 1, characterized in that The loading mechanism (8) is constituted by a set of 4 curved tubes having valves at their ends and/or capped with threaded caps (21), held by the top flange (27).

7. The regulator equipment according to claim 6, characterized in that the loading mechanism (8) comprises a push element generically named “stick” (22), which is introduced after the spheres are added in order to force them to correctly lodging in their respective track.

8. The regulator equipment according to claim 7, characterized in that the loading mechanism (8) comprises a different stick and a special configuration according to each sphere size.

9. The regulator equipment according to claim 1, characterized in that the control mechanism (9) consists in an open loop control system, in which a control point is established in a velocity changer by the frequency.

10. The regulator equipment according to claim 9, characterized in that the control mechanism (9) externally reflects the position of the main nut (12) and in turn, acts on two run end switches (28), influencing in the control logic of the velocity changer.

11. The regulator equipment according to claim 1, characterized in that the driving system of the equipment is formed by an electric motor (10) with a power of between 2 to 5 HP, and a velocity reducer (29) directly and axially coupled both to the electric motor and the main screw of the regulator.

12. The regulator equipment according to claim 11, characterized in that the driving system of the equipment is formed by a 3 HP electric motor (10).

13. The regulator equipment according to any of the preceding claims, characterized in that driving in the inside remains pressurized at the transport tubing pressure, that is, between 101.3 and 17400 kPa.

14. The regulator equipment according to any of the preceding claims, characterized in that the geometric elements are unloaded onto the T (16) which is located in the by-pass (17).

15. The regulator equipment according to any of the preceding claims, characterized in that in addition comprises a platform (23) constituted by a raised platform with safety fences and access stairway.

16. A process for blocking leaks caused by non-authorized unauthorized shunts characterized in that it comprises the following steps:
injecting into the fluid stream geometric elements having various materials and geometric shapes (2) through the dosing equipment according to anyone of the previous claims.
circulating the elements within the fluid which by hydraulic effects block the unauthorized shunts (4) avoiding or making difficult the product extraction.
recovering the elements at the end of the duct using a filter as a trap (5) which catches these elements without causing any harm on them, the process ends in the receiving station (6).

17. A process according to claim 16 characterized in that the injection of the blocking elements is carried out at a pressure between 101.3 and 17400 kPa.

18. A process according to claim 16 characterized in that the introduction frequency is between 1 and 20 geometric elements per minute.

19. A process according to claim 18 characterized in that the introduction frequency is between 2 to 7 geometric elements per minute.

20. A process according to claim 16 characterized in that the preferred geometric elements are spheres.

21. A process according to claim 20 characterized in that the density of the spheres is between 40% and 120% of the fluid density.

22. A process according to claim 20 characterized in that the density of the spheres is between 0.4 and 1.2 g/cm³.

23. A process according to claim 20 characterized in that said spheres are made of polyolefins, foaming and/or mixtures thereof.

24. A process according to claim 20 characterized in that the relation between the sphere dimension and the conduit dimension must be between 1 and 10.

25. A process according to claim 20 characterized in that the relation between the sphere dimension and the conduit dimension must be between 1 and 4.

26. A process according to claim 16 characterized in that the step of collecting the spheres is carried out through a collecting filter which has a cylinder shape and is located at the downstream end of the conduit.

27. A process according to claim 26 characterized in that the collector filter consists of a vertical cylinder shaped body having a cylinder net, respective strengthening pieces, sit and handles.
